(19) United States
(12) Patent Application Publication
(10) Pub. No.: US 2014/0125929 A1
(43) Pub. Date: May 8, 2014

(54) LIQUID CRYSTAL PANEL, ITS MANUFACTURING METHOD, AND LIQUID CRYSTAL DISPLAY DEVICE

(71) Applicant: BOE TECHNOLOGY GROUP CO., LTD., Beijing (CN)

(72) Inventors: Miki KASHIMA, Beijing (CN); Teruaki SUZUKI, Beijing (CN)

(73) Assignee: BOE TECHNOLOGY GROUP CO., LTD., Beijing (CN)

(21) Appl. No.: 14/069,891

(22) Filed: Nov. 1, 2013

(30) Foreign Application Priority Data
Nov. 2, 2012 (CN) 2012 10 434442.8

(51) Int. Cl. G02F 1/1335

(52) U.S. Cl. CPC G02F 1/133514; G02F 1/133516
USPC 349/106; 445/24

(57) ABSTRACT

The present invention provides a liquid crystal panel, its manufacturing method, and a liquid crystal display device. The liquid crystal panel comprises: a first substrate and a second substrate arranged opposite to each other; a scattering type liquid crystal layer arranged between the first substrate and the second substrate and capable of being switched between a dark state and a bright state; and a color filter layer arranged between the first substrate and the second substrate. According to the present invention, a transparent/translucent liquid crystal panel capable of realizing color display is obtained.

### CROSS REFERENCE

The present application claims priority to the Chinese application No. 201210434442.8 filed on Nov. 2, 2012, the entire contents of which are incorporated herein by reference.

### TECHNICAL FIELD

The present invention relates to the field of liquid crystal display, in particular to a liquid crystal panel, its manufacturing method, and a liquid crystal display device.

### BACKGROUND

Liquid crystal display (LCD) is a device for displaying an image by using optical anisotropy and birefringence characteristic of liquid crystal molecules, and generally a thin film transistor (TFT) is used as a switching element.

However, a polarized plate must be used in a common LCD, and prior to be displayed to the outside, essentially about 70% to 80% of the incident light from a backlight unit will be lost. For this reason, there is a problem of low optical efficiency in the LCD.

To resolve this problem, a polymer dispersed liquid crystal (PDLC) display device has been developed, where a small molecular liquid crystal is mixed with a prepolymer to form, by polymerization under certain conditions, micron-scale liquid crystal droplets that are dispersed uniformly in a polymer network, thereby to obtain a material with electro-optical response characteristics by using dielectric anisotropy of the liquid crystal molecules.

A PDLC layer can work in both a scattering state and a transparent state, i.e., it can display information on a screen with or without voltage applied thereto and can achieve transparency without or with voltage applied thereto, so it is able to see through the screen the objects behind the screen.

Of course, the transparency display may also be implemented in other ways.

However, it is impossible for the current transparent or translucent liquid crystal panels to display the information in different colors.

### SUMMARY

An object of the present invention is to provide a liquid crystal panel, its manufacturing method, and a liquid crystal display device, so as to acquire a transparent or translucent liquid crystal panel that can display information in different colors.

In one aspect, the present invention provides a liquid crystal panel, comprising:

a first substrate and a second substrate arranged opposite to each other;

a scattering type liquid crystal layer arranged between the first substrate and the second substrate and capable of being switched between a dark state and a bright state; and

a color filter layer arranged between the first substrate and the second substrate.

In the above liquid crystal panel, the color filter layer is arranged between the first substrate and the liquid crystal layer.

In the above liquid crystal panel, the color filter layer is arranged between the second substrate and the liquid crystal layer.

In the above liquid crystal panel, the scattering type liquid crystal layer is a polymer dispersed liquid crystal layer, or a mixing layer of polymerizable monomers and liquid crystals.

In the above liquid crystal panel, a pixel electrode is arranged on the first substrate and a common electrode is arranged on the second substrate, or a common electrode is arranged on the first substrate and a pixel electrode is arranged on the second substrate, wherein the scattering type liquid crystal layer may be switched between a dark state and a bright state through controlling application of electric field between the pixel electrode and the common electrode.

In the above liquid crystal panel, in the dark state, the scattering type liquid crystal layer is transparent; in the bright state, the light entering the scattering type liquid crystal layer is scattered therein.

In another aspect, the present invention provides a liquid crystal display device comprising the above liquid crystal panel.

In yet another aspect, the present invention provides a method for manufacturing a liquid crystal panel, comprising a step of forming a first substrate, a step of forming a scattering type liquid crystal layer capable of being switched between a dark state and a bright state, and a step of forming a second substrate. The step of forming the first substrate or second substrate further comprises a step of forming a color filter layer. The first substrate and the second substrate are arranged opposite to each other, and the color filter layer is arranged between the first substrate and the second substrate.

In the above method, the color filter layer is arranged between the first substrate and the liquid crystal layer.

The above method further comprises:

curing the scattering type liquid crystal layer by irradiating it with UV rays to form a polymer network.

The above method further comprises:

curing a sealant between the first substrate and the second substrate with UV rays.

The above method further comprises:

curing the scattering type liquid crystal layer to form a polymer network and a sealant between the first substrate and the second substrate with UV rays synchronously.

In the above method, the color filter layer is arranged between the second substrate and the liquid crystal layer.

The above method further comprises: forming a liquid crystal cell, wherein the scattering type liquid crystal layer is sandwiched between the first substrate and the second substrate to form the liquid crystal cell.

The present invention at least has the following beneficial effect.

In the liquid crystal panel of embodiments of the present invention, when the scattering type liquid crystal panel is in the dark state, the ambient light/spotlight reflected by an object behind the display device can pass through the liquid crystal panel, so that a user can see the object behind the display device. When the scattering type liquid crystal layer is in the bright state, the light entering the scattering type liquid crystal layer will be scattered therein, and specific light will enter the user's eyes under the effect of the color filter layer and the voltage, thereby color display will be achieved.

### BRIEF DESCRIPTION OF THE DRAWINGS

FIG. 1 is a schematic view showing the structure of a liquid crystal panel according to an embodiment of the present invention;

FIG. 2 is a schematic view showing the working principle of the liquid crystal panel as shown in FIG. 1;

FIG. 3 is schematic view showing the structure of another liquid crystal panel according to another embodiment of the present invention; and

FIG. 4 is a schematic view showing the working principle of the liquid crystal panel as shown in FIG. 3.

### DETAILED DESCRIPTION

According to a liquid crystal panel and its manufacturing method of the present invention, a color filter layer is arranged between two substrates, so that the light with a specific color can be reflected by the color filter layer and/or can pass through the color filter layer, thereby a user can see a color image.

The liquid crystal panel of the present invention comprises:

a first substrate and a second substrate arranged opposite to each other;

a scattering type liquid crystal layer arranged between the first substrate and the second substrate and capable of being switching between a dark state and a bright state; and

a color filter layer arranged between the first substrate and the second substrate.

According to the liquid crystal panel of the present invention, when the scattering type liquid crystal layer is in the dark state, ambient light/spotlight reflected by an object behind a display device can pass through the liquid crystal panel so that the user can see the object behind the display device. When the scattering type liquid crystal layer is in the bright state, the light entering the scattering type liquid crystal layer will be scattered therein, and under the effect of the color filter layer and voltage, special light can enter the user's eyes, thereby a color display will be achieved.

In an embodiment of the present invention, the color filter layer may be arranged at the first substrate or the second substrate. The arrangement of the color filter layer is described hereinafter by taking the first substrate and the second substrate, which are an array substrate and an upper substrate respectively, as an example.

Mode 1 for Arranging Color Filter Layer

In this mode, the color filter layer is arranged at the substrate opposite to the array substrate.

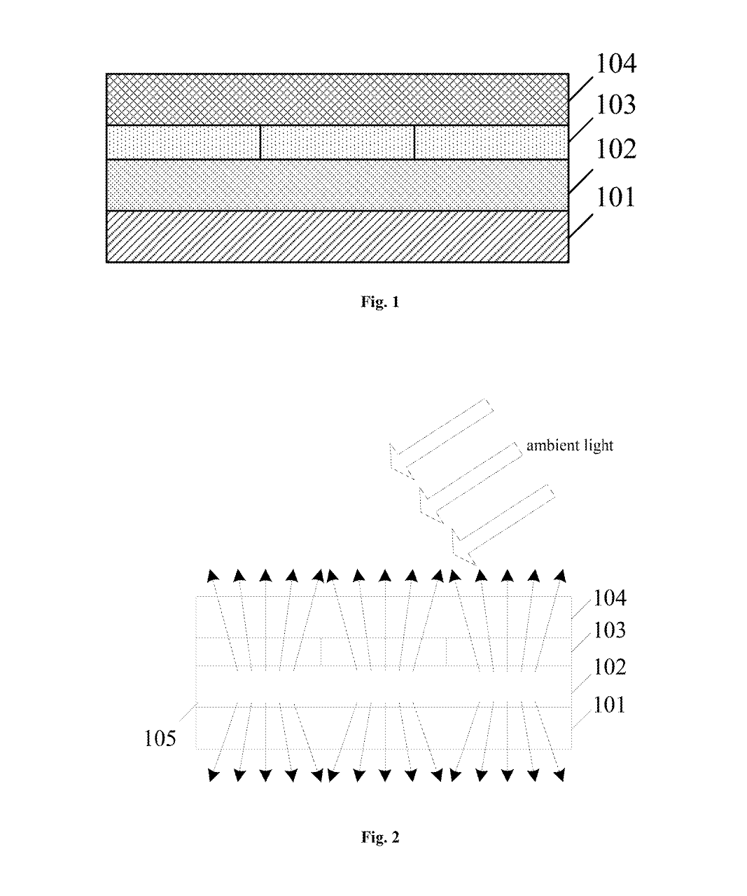

As shown in FIG. 1, the liquid crystal panel of the present invention comprises:

a transparent array substrate 101 and an upper substrate 104 arranged opposite to each other;

a scattering type liquid crystal layer 102 arranged between the transparent array substrate 101 and the upper substrate 104; and

a color filter layer 103 arranged between the transparent array substrate 101 and the upper substrate 104,

wherein the color filter layer is arranged at a surface of the upper substrate 104 facing the array substrate 101.

In the embodiment as shown in FIG. 1, the color filter layer is an uppermost filter layer facing the array substrate 101 on the upper substrate 104. However, it should be appreciated that, the color filter layer may also be any filter layer on the upper substrate 104.

The operation of the liquid crystal panel according to the present invention will be described hereinafter merely under the condition as shown in FIG. 1.

When the liquid crystal panel is in the dark state, a background object behind the liquid crystal panel will reflect ambient light, which enters the scattering type liquid crystal layer 102 from the transparent array substrate 101. Because the scattering type liquid crystal layer 102 is transparent in the dark state, most of the light reflected by the background object and entering the scattering type liquid crystal layer 102 will be projected onto the color filter layer 103.

After the light is projected onto the color filter layer 103, the light with a specific color will pass through the color filter layer, emerge from a surface of the upper substrate 104 and enter the user's eyes, so that the use can see the background object.

When the liquid crystal panel is in the bright state, it will be analyzed in two parts as follows.

1. Background Object

The background object behind the liquid crystal panel will reflect the ambient light, which will enter the scattering type liquid crystal layer 102 from the transparent array substrate 101. Because in the bright state, subpixel units of the scattering type liquid crystal layer 102 show different states, for each subpixel, the light entering the subpixel unit will be projected onto the color filter layer in different proportions. In this case, the color of the background object is not true, and the brightness thereof is lower than that in the dark state.

2. Display Picture

When the liquid crystal panel is in the bright state, the liquid crystals corresponding to the subpixels will be in different states by controlling an electrical signal applied to a pixel electrode and a common electrode.

When the liquid crystal corresponding to a subpixel is in a special state, for the light entering the liquid crystal panel (including the ambient light entering the liquid crystal panel from the transparent array substrate 101 or the upper substrate 104, or the backlight emitted from a backlight unit and entering the liquid crystal panel), only the light with a specific proportion (which is associated with the liquid crystal state, or with the electrical signal applied to the pixel electrode and the common electrode) can emerge from the upper substrate 104 and enter the user's eyes.

For each pixel, the proportion of the red, green and blue rays emerging from the surface of the upper substrate 104 can be controlled by setting the color filter layer 103 and the liquid crystal state, so as to display the colors for the pixels.

Of course, in embodiments of the present invention, the color filter layer may be a filter layer in red, green and blue colors, or a filter layer in red, green, blue and white colors, or any other color filter layers.

In embodiments of the present invention, the color filter layer is arranged at the substrate opposite to the allay substrate. When the ambient light is used as a light source, the color filter layer will take effect twice, so the color gamut of the liquid crystal panel can be increased.

As shown in FIG. 2, the ambient light enters the liquid crystal panel from the surface of the upper substrate 104. Before entering the liquid crystal layer 102, the light needs to pass through the color filter layer 103, and at this time, the color filter layer 103 will take effect for the first time. Before the light reflected by the liquid crystal layer emerges from the surface of the upper substrate 104, it also needs to pass through the color filter layer 103, and at this time, the color filter layer 103 will take effect for the second time.

It should be appreciated that, the above description is made based on the dark state and bright state of the entire liquid crystal display device. However, each subpixel can be independently controlled in the dark or bright state. The operation mode thereof is the same as that mentioned above, and thus will not be repeated herein.

Mode 2 for Arranging Color Filter Layer

In this mode, the color filter layer is arranged at the array substrate.

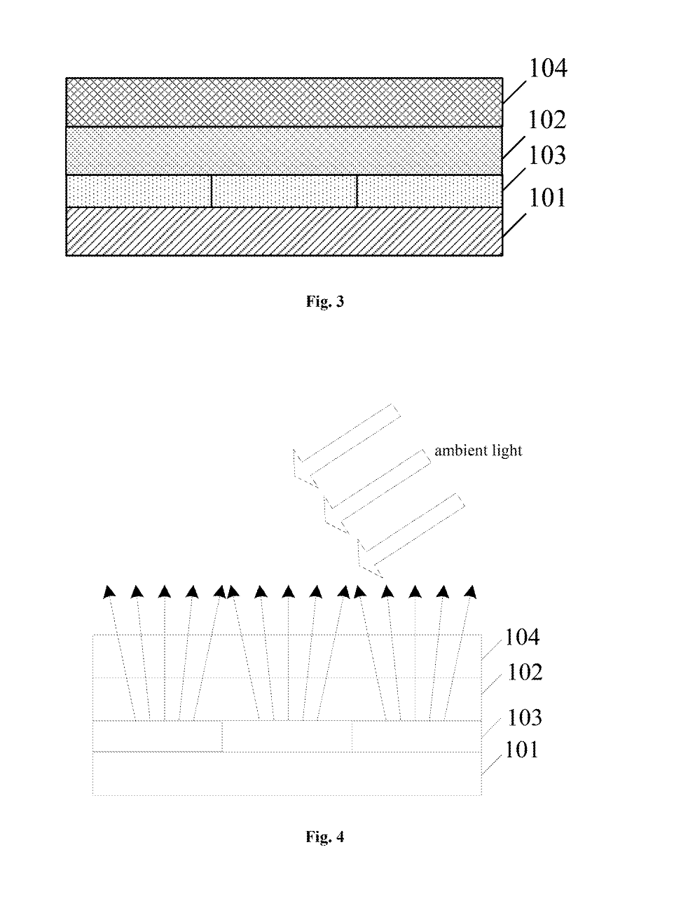

As shown in FIG. 3, the liquid crystal panel according to embodiments of the present invention comprises:

a transparent array substrate 101 and an upper substrate 104 arranged opposite to each other;

a scattering type liquid crystal layer 102 arranged between the transparent array substrate 101 and the upper substrate 104; and

a color filter layer 103 arranged between the transparent array substrate 101 and the upper substrate 104,

wherein the color filter layer 103 is arranged on a surface of the array substrate 101 close to the upper substrate 104.

In the embodiment as shown in FIG. 3, the color filter layer is an uppermost filter layer facing the upper substrate 104 on the array substrate 101. However, it should be appreciated that, the color filter layer may also be any filter layer on the array substrate 101.

The operation of the liquid crystal panel according to the present invention will be described hereinafter merely based on the condition as shown in FIG. 3.

When the liquid crystal panel is in the dark state, a background object behind the liquid crystal panel will reflect ambient light, which enters the scattering type liquid crystal layer 102 from the transparent array substrate 101 through the color filter layer 103.

In the dark state, the scattering type liquid crystal layer 102 is transparent. At this time, most of the light reflected by the background object and entering the scattering type liquid crystal layer 102 will pass through the scattering type liquid crystal layer 102, emerge from the upper substrate 104 and enter the user's eyes, so that the user can see the background object.

When the liquid crystal panel is in the bright state, it will be analyzed in two parts as follows.

1. Background Object

The background object behind the liquid crystal panel will reflect the ambient light, which will enter the scattering type liquid crystal layer 102 from the transparent array substrate 101 through the color filter layer 103.

Because in the bright state, subpixel units of the scattering type liquid crystal layer 102 show different states, for each subpixel, the light entering the subpixel unit will be projected onto the upper substrate 104 in different proportions. In this case, the color of the background object is not true, and the brightness thereof is lower than that in the dark state.

2. Display Picture

When the liquid crystal panel is in the bright state, the liquid crystals corresponding to the subpixels will be in different states by controlling an electrical signal applied to a pixel electrode and a common electrode.

When the liquid crystal corresponding to a subpixel is in a specific state, for the light entering the liquid crystal panel (including the ambient light entering the liquid crystal panel from the transparent array substrate 101 or the upper substrate 104, or the backlight emitted from a backlight unit and entering the liquid crystal panel), only the light with a specific proportion (which is associated with the liquid crystal state, or with the electrical signal applied to the pixel electrode and the common electrode) can emerge from the upper substrate 104 and enter the user's eyes.

For each pixel, the proportion of the red, green and blue rays emerging from the upper substrate 104 can be controlled by setting the color filter layer 103 and the liquid crystal state, so as to display colors for the pixels.

Of course, in embodiments of the present invention, the color filter layer may be a filter in red, green and blue colors, or a filter in red, green, blue and white colors, or any other color filters.

In embodiments of the present invention, the color filter layer is arranged at the array substrate. When the ambient light is used as a light source, the color filter layer will take effect only once, so the brightness of the liquid crystal panel can be increased.

As shown in FIG. 4, the ambient light enters the liquid crystal panel from the surface of the upper substrate 104. After entering the liquid crystal layer 102, a part of the light will be projected onto the color filter layer 103, and then emerge from the surface of the upper substrate 104 after being reflected by the color filter layer 103.

As compared to mode 1, this mode can increase the light utilization and brightness.

Meanwhile, it is relatively easy to arrange the color filter layer at the array substrate, and the product quality can be improved. Detailed explanations are given as follows.

The scattering type liquid crystal layer may be a mixing layer of polymerizable monomers and liquid crystals. For such a combination, it needs to cure the mixing layer with UV (Ultra-Violet) rays during the formation of the scattering type liquid crystal layer, so as to form a polymer network.

If the color filter layer is arranged on the upper substrate, the light intensity of UV rays will easily be uneven due to the structure of the color filter layer when the liquid crystal layer is cured with UV rays from the upper substrate. When the liquid crystal layer is cured with UV rays from the lower substrate, on one hand, the TFT characteristics will be damaged easily and the illumination will be uneven due to the occlusion of signal lines, and on the other hand, the process will be complex if the liquid crystal layer is cured with UV rays from the bottom up.

However, there will be no such problems when the color filter layer is arranged on the array substrate. Detailed explanations are given hereinafter.

1. When the color filter layer is arranged at the array substrate, the liquid crystal layer is cured with UV rays from the upper substrate. In terms of an incident direction of UV rays, UV rays merely need to pass through the transparent substrate before arriving at the liquid crystal layer. The color filter layer and the signal line will no longer affect the intensity distribution of UV rays, so it is able to cure the liquid crystal layer evenly.

2. The liquid crystal layer is cured with UV rays from the upper substrate, so the TFT will no longer be damaged, and the product quality can be improved.

3. The liquid crystal layer is cured with UV rays from the upper substrate, so the process is of less complexity.

In the embodiment of the present invention, the method further comprises: curing a sealant between the first substrate and the second substrate with UV rays. Specially, when the scattering type liquid crystal layer is cured with UV rays in a direction from the second substrate toward the first substrate to form a polymer network, a sealant between the first substrate and the second substrate will also be cured with UV rays, so the process will be simplified.

An embodiment of the present invention further provides a method for manufacturing a liquid crystal panel, comprising a step of forming a first substrate, a step of forming a scattering type liquid crystal layer capable of being switched between a dark state and a bright state, and a step of forming a second substrate. The step of forming the first substrate or second substrate further comprises a step of forming a color filter layer. The first substrate and the second substrate are arranged opposite to each other, and the color filter layer is arranged between the first substrate and the second substrate.

The manufacturing method according to the embodiment of the present invention will vary along with different positions of the color filter layer. When the color filter layer is arranged between the first substrate corresponding to the first substrate and the liquid crystal layer, i.e., when the color filter layer is arranged on the array substrate, the manufacturing method comprises:

Step 201: forming a first substrate; wherein Step 201 further including: forming a color filter layer on the first substrate;

Step 202: forming a first transparent electrode on the color filter layer;

Step 203: forming a scattering type liquid crystal layer capable of being switched between the dark state and the bright state on the color filter layer;

Step 204: forming a second substrate;

Step 205: forming a second transparent electrode on the second substrate;

Step 206: forming a liquid crystal cell, wherein the scattering type liquid crystal layer is sandwiched between the first substrate and the second substrate to form the liquid crystal cell; and

Step 207: curing the scattering type liquid crystal layer with UV rays to form a polymer network.

The scattering type liquid crystal layer may be a mixing layer of polymerizable monomers and liquid crystals. The manufacturing method further comprises curing the scattering type liquid crystal layer with UV rays in a direction from the second substrate toward the first substrate to form a polymer network, and curing a sealant between the first substrate and the second substrate.

When the color filter layer is arranged between the second substrate corresponding to the second substrate and the liquid crystal layer, the method for manufacturing a liquid crystal layer comprises:

Step 301: forming a first substrate;

Step 302: arranging a first transparent electrode on the first substrate;

Step 303: forming a scattering type liquid crystal layer capable of being switched between the dark state and the bright state on the first substrate;

Step 304: forming a second substrate; wherein Step 304 further including: forming a color filter layer on the second substrate;

Step 305: forming a second transparent electrode;

Step 306: forming a liquid crystal cell, wherein the scattering type liquid crystal layer is sandwiched between the first substrate and the second substrate to form a liquid crystal cell; and

Step 307: curing the scattering type liquid crystal layer with UV rays to form a polymer network.

The embodiments of the present invention also provide a liquid crystal display (LCD) device comprising the liquid crystal panel in the above embodiments, and thus the beneficial technical effects achievable by the liquid crystal panel can also be realized by it. A detailed description has been made in the preceding sections, and details are omitted here. The LCD device may be a LCD panel, a mobile phone, a computer or a TV set.

The above are merely the preferred embodiments of the present invention. It should be noted that, a person skilled in the art may make improvements and modifications without departing from the principle of the present invention, and these improvements and modifications shall also be considered as the scope of the present invention.

What is claimed is:

1. A liquid crystal panel, comprising:
a first substrate and a second substrate arranged opposite to each other;
a scattering type liquid crystal layer arranged between the first substrate and the second substrate and capable of being switched between a dark state and a bright state; and
a color filter layer arranged between the first substrate and the second substrate.

2. The liquid crystal panel according to claim 1, wherein the color filter layer is arranged between the first substrate and the liquid crystal layer.

3. The liquid crystal panel according to claim 1, wherein the color filter layer is arranged between the second substrate and the liquid crystal layer.

4. The liquid crystal panel according to claim 1, wherein the scattering type liquid crystal layer is a polymer dispersed liquid crystal layer, or a mixing layer of polymerizable monomers and liquid crystals.

5. The liquid crystal panel according to claim 1, wherein
a pixel electrode is arranged on the first substrate and a common electrode is arranged on the second substrate, or
a common electrode is arranged on the first substrate and a pixel electrode is arranged on the second substrate,
wherein the scattering type liquid crystal layer is switched between the dark state and the bright state through controlling application of electric field between the pixel electrode and the common electrode.

6. The liquid crystal panel according to claim 1, wherein
in the dark state, the scattering type liquid crystal layer is transparent;
in the bright state, the light entering the scattering type liquid crystal layer is scattered therein.

7. A liquid crystal display device, comprising the liquid crystal panel according to claim 1.

8. The liquid crystal display device according to claim 7, wherein the color filter layer is arranged between the first substrate and the liquid crystal layer.

9. The liquid crystal display device according to claim 7, wherein the color filter layer is arranged between the second substrate and the liquid crystal layer.

10. The liquid crystal display device according to claim 7, wherein the scattering type liquid crystal layer is a polymer dispersed liquid crystal layer, or a mixing layer of polymerizable monomers and liquid crystals.

11. The liquid crystal display device according to claim 7, wherein
a pixel electrode is arranged on the first substrate and a common electrode is arranged on the second substrate, or
a common electrode is arranged on the first substrate and a pixel electrode is arranged on the second substrate,
wherein the scattering type liquid crystal layer is switched between the dark state and the bright state through controlling application of electric field between the pixel electrode and the common electrode.

12. The liquid crystal display device according to claim 7, wherein
in the dark state, the scattering type liquid crystal layer is transparent;
in the bright state, the light entering the scattering type liquid crystal layer is scattered therein.

13. A method for manufacturing a liquid crystal panel, comprising a step of forming a first substrate, a step of forming a scattering type liquid crystal layer capable of being switched between a dark state and a bright state, and a step of forming a second substrate, wherein the step of forming the first substrate or the second substrate further comprises a step of forming a color filter layer, the first substrate and the second substrate are arranged opposite to each other, and the color filter layer is arranged between the first substrate and the second substrate.

14. The method according to claim 13, wherein the color filter layer is arranged between the first substrate and the liquid crystal layer.

15. The method according to claim 13, wherein the method further comprises:
curing the scattering type liquid crystal layer with UV rays to form a polymer network.

16. The method according to claim 13, wherein the method further comprises:
curing a sealant between the first substrate and the second substrate with UV rays.

17. The method according to claim 13, wherein the method further comprises:
curing the scattering type liquid crystal layer to form a polymer network and a sealant between the first substrate and the second substrate with UV rays synchronously.

18. The method according to claim 13, wherein the color filter layer is arranged between the second substrate and the liquid crystal layer.

19. The method according to claim 13, the method further comprises:
forming a liquid crystal cell, wherein the scattering type liquid crystal layer is sandwiched between the first substrate and the second substrate to form the liquid crystal cell.
